(19) United States
(12) Patent Application Publication
(10) Pub. No.: US 2007/0259543 A1
(43) Pub. Date: Nov. 8, 2007

(54) Pressure device for test socket

(75) Inventor: Wayne (Wen-Yi) Hsieh, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD

(21) Appl. No.: 11/799,718

(22) Filed: May 1, 2007

(30) Foreign Application Priority Data
May 2, 2006 (TW) 95207446

(51) Int. Cl. H01R 12/00

(52) U.S. Cl. 439/73

(57) ABSTRACT

A pressure device for a test socket includes a main pressure body (70) defining a substantially rectangular opening sized to allow a sub-pressure body (60) to be therewithin, and the sub-pressure body accommodated within the main pressure body. At least one passage (601, 701) is formed on lateral sections between the main pressure body and the sub-pressure body. A fastening member (10) is to be within the at least one passage for fastening the sub-pressure body to the main pressure body, and includes a core section (101) and an end (102) attached to the core section. The end of the fastening member defines a surface shaped to facilitate a wrench to be engaged therewithin, which is easy to extract the fastening member from the passages of the main pressure body and the sub-pressure body by the use of the conventional wrench available in the factory.

### BACKGROUND OF THE INVENTION

1. Field of the Invention

The present invention relates to the art of electrical connectors, and more particularly to a pressure device for a test socket.

2. Description of the Related Art

One conventional test socket 1′ is shown in FIG. 4 to include a socket body 20′ with a plurality of terminals 30′ resided therein, and a floating frame 50′ resiliently mounted upon the socket body 20′ by springs 40′ disposed between the floating frame 50′ and adapted to receive an IC package (not shown). The floating frame 50′ is movable relative to the socket body 20′ so as to allow the terminals 30′ to be located beyond the floating frame 50′ for engaging conductive elements of the IC package. The test socket 1′ further includes a pressure device adapted to be mounted upon the IC package for providing pressure force of the IC package sufficient to establish a reliable electrical connection between the conductive elements of the IC package and the terminals 30′ of the test socket 1′. Such a pressure device typically includes a main pressure body 80′ pivotably attached to an end of the socket body 20′, a cover 90′ pivotably attached to an opposite end of the socket body 20′, and a sub-pressure body 60′ accommodated within an opening of the main pressure body 80′. The sub-pressure body 60′ is attached to the main pressure body 80′ by laterally extending fastening elements 10′ provided between the sub-pressure body 60′ and the main pressure body 80′. More specifically, the main pressure body 80′ and the sub-pressure body 60′ are provided with holes 600′ and 800′ at lateral sections thereof, the holes 600′ and 800′ adapted for the fastening elements 10′ to be inserted therein. The fastening elements 10′ are in forms of pin, which define a slot 100′ along at least a part of each fastening element 10′ for facilitating insertion of a retention sheet 801′ through an elongated recess 802′ of the main pressure body 80′ so as to form a mechanical interconnection between the main pressure body 80′ and the sub-pressure body 60′. Since the test socket 1′ is adapted for receiving different IC packages varying in size, the main pressure body 80′ and the sub-pressure body 60′ are often unassembled or assembled to achieve the interconnection therebetween by frequently inserting the retention sheets 801′ into the slots 100′ of the fastening elements 10′ on the sub-pressure body 60′ through the recesses 802′ of the main pressure body 80′, thereby often causing the damage to the test socket 1′ due to the frequent insertions of the retention sheets 801′. Further, the insertion of the retention sheet 801′ is not easily done, and needs a specific tool to do that, which makes operation of the test socket 1′ so complicated and time-consuming. Therefore, there is a need to provide a pressure device for a test socket to resolve the above-mentioned shortcomings.

### SUMMARY OF THE INVENTION

A pressure device for a test socket according to one embodiment of the present invention includes a main pressure body, a sub-pressure body accommodated within the main pressure body. The main pressure body defines a substantially rectangular opening sized to allow the sub-pressure body to be therewithin. The sub-pressure body is on the main pressure body. At least one passage is formed on lateral sections between the main pressure body and the sub-pressure body. A fastening member is to be within the at least one passage for fastening the sub-pressure body to the main pressure body, and includes a core section and an end attached to the core section. The end of the fastening member defines a surface shaped to facilitate a wrench to be engaged therewithin, which is easy to extract the fastening member from the passages of the main pressure body and the sub-pressure body by the use of the conventional wrench available in the factory.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is an exploded, perspective view of a test socket according to a preferred embodiment of the present invention, showing a pressure device thereof;

FIG. 2 is an enlarged view of a fastening member of FIG. 1;

FIG. 3 is an assembled, perspective view of the test socket of FIG. 1; and

FIG. 4 is an exploded, perspective view of a conventional test socket.

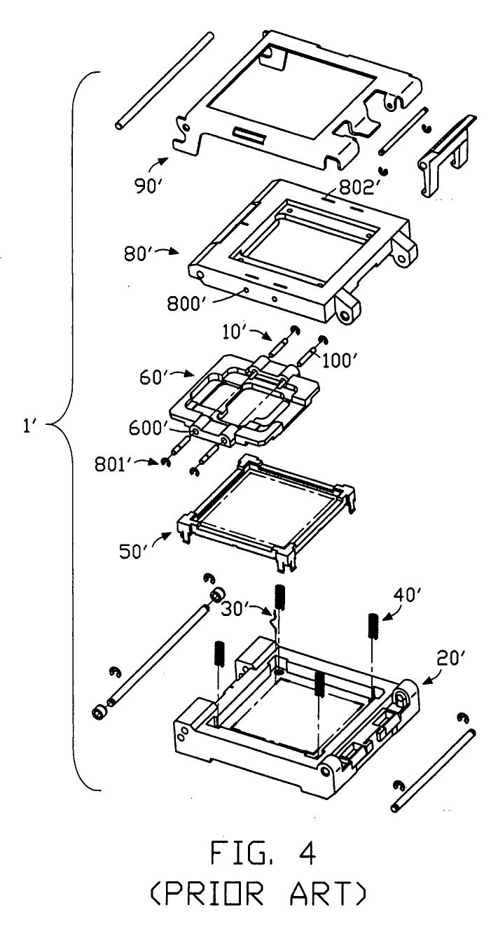

### DETAILED DESCRIPTION OF PREFERRED EMBODIMENT

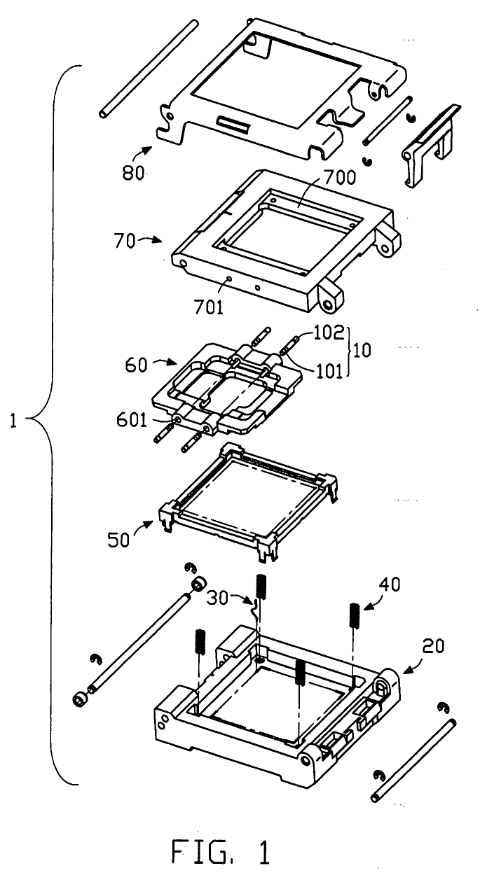

Referring to FIGS. 1 to 3, a test socket 1 includes a socket body 20 with a plurality of terminals 30 resided therein, and a floating frame 50 resiliently mounted upon the socket body by springs 40 disposed between the floating frame 50 and adapted to receive an IC package (not shown). The floating frame 50 is movable relative to the socket body in a longitudinal direction so as to allow the terminals 30 to be located beyond the floating frame 50 for engaging conductive elements of the IC package. The test socket 1 further includes a pressure member adapted to be mounted upon the IC package for providing pressure force of the IC package sufficient to establish a reliable electrical connection between the conductive elements of the IC package and the terminals 30 of the test socket 1.

Referring to FIG. 1, the pressure device according to the preferred embodiment of the present invention includes a main pressure body 70 pivotably attached to an end of the socket body 20, a cover 80 pivotably attached to an opposite end of the socket body 20, and a sub-pressure body 60 accommodated within the main pressure body 70. More specifically, the main pressure body 70 defines a substantially rectangular opening 700 sized to allow the sub-pressure body 60 to be accommodated therewithin. The sub-pressure body 60 is disposed on the main pressure body 70. A pair of passages 601 and 701 is formed on lateral sections between the main pressure body 70 and the sub-pressure body 60 and adapted for a fastening member 10 to be inserted into each of the passages 601 and 701 so as to form a mechanical interconnection between the main pressure body 70 and the sub-pressure body 60.

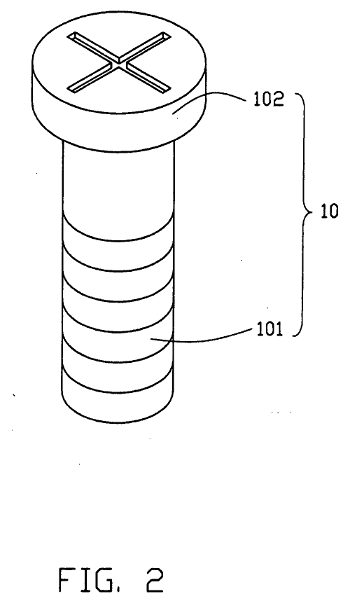

As shown in FIG. 2, the fastening member 10 is to be within the passage 601 and 701 for fastening the sub-pressure body 60 to the main pressure body 70, and includes a core section 101 and an end 102 attached to the core section 101. The end of each fastening member 102 defines a surface shaped to facilitate a wrench (not shown, as known in the art) to be engaged therewith so as to extract the fastening member 10 from the main pressure body 70 and the sub-pressure body 60 by the use of the wrench available in the factory. The surface of the end 102 is recessed at a central portion thereof for the wrench to engage therewith. In this embodiment, the end 102 has a recessed portion being of a cross shape. However, in alternative embodiments, the end 102 may have any suitable recessed shape other than the cross shape in this embodiment. The end 102 may be exposed to the exterior, or be within the passages 601 and 701. Each fastening member core section 101 and the passages 601 and 701 associated therewith have complementary interengaging threaded surfaces for permitting the fastening member 10 to remain a lateral movement during the insertion of the fastening member 10 into the passages 601 and 701 of the main pressure body 70 and the sub-pressure body 60, and secure in a predetermined location when the fastening member 10 is no longer moveable along the passages 601 and 701, thereby forming a mechanical interconnection between the main pressure body 70 and the sub-pressure body 60. As compared with the prior art, the configuration and shape of the fastening member 10 facilitate a conventional wrench to be engaged therewith, not by the use of a specific tool, which is easy to extract the fastening member 10 from the passages 601 and 701 of the main pressure body 70 and the sub-pressure body 60 by the use of the conventional wrench available in the factory.

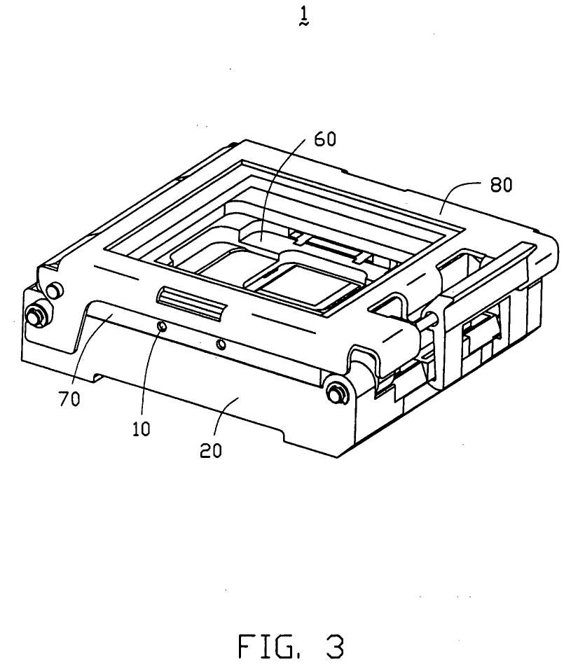

Referring to FIGS. 1 and 3, in assembly, the floating frame 50 is resiliently mounted upon the socket body 20 by springs 40 disposed between the socket body 20 and the floating frame 50, and adapted to receive the IC package thereon. The sub-pressure body 10 is attached to the main pressure body 70 by the fastening members 10 laterally insertable into the passages 601 and 701 of the main pressure body 70 and sub-pressure body 60 so as to achieve the mechanical interconnection between the main pressure body 70 and the sub-pressure body 60. The assembled main pressure body 70 and sub-pressure body 60 is then mounted upon the floating frame 50 by the main pressure body 70 pivotably attached to one end of the socket body 20. And the cover 80 is pivotably attached to the opposite end of the socket body 20 in order to hold the test socket 1 in a closed position.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. A pressure device for a test socket comprising:
a main pressure body, the main pressure body defining a substantially rectangular opening sized to allow a sub-pressure body to be accommodated therewithin;
the sub-pressure body on the main pressure body;
at least one passage formed on lateral sections between the main pressure body and the sub-pressure body;
a fastening member within the at least one passage for fastening the sub-pressure body to the main pressure body, the fastening member having a core section and an end attached to the core section, the end defining a surface shaped to facilitate a wrench to be engaged therewith.

2. The pressure device of claim 1, wherein the core section and the at least one passage have complementary interengaging threaded surfaces.

3. The pressure device of claim 1, wherein the surface of the end is recessed at a central portion thereof for the wrench to engage therewith.

4. The pressure device of claim 3, wherein the end has a recessed portion being of a cross shape.

5. A pressure device used in a test socket comprising:
a socket body with a floating frame up and down moveable therewith;
a plurality of terminals disposed in the socket body;
a cover pivotally located atop the socket body;
a main pressure body pivotally mounted under the cover and defining a rectangular opening sized to allow a sub-pressure body to be accommodated therewithin;
a first passage formed in a lateral section of the main pressure body;
a second passage formed in a lateral region of the sub-pressure body and being alignment with the first passage; and
a screw extending through the first passage and into the second passage; wherein
the main pressure body and the sub-pressure body are fastened together via threads of the screw, and the screw defines a head laterally accessible from an exterior so as to actuate the screw for assembling or disassembling the sub-pressure body and the main pressure body.
